(19) United States
(12) Patent Application Publication
(10) Pub. No.: US 2025/0220516 A1
(43) Pub. Date: Jul. 3, 2025

(54) DECLARATION OF RADIO LINK FAILURE IN MULTI-PANEL TX SCENARIO

(71) Applicant: LENOVO (BEIJING) LIMITED, Beijing (CN)

(72) Inventors: Ran YUE, Beijing (CN); Lianhai WU, Beijing (CN); Haiming WANG, Beijing (CN); Jing HAN, Beijing (CN); Min XU, Beijing (CN); Jie HU, Beijing (CN)

(21) Appl. No.: 18/850,304

(22) PCT Filed: Mar. 25, 2022
(86) PCT No.: PCT/CN2022/083062

§ 371 Date: Sep. 24, 2024

(51) Int. Cl. H04W 36/00; H04W 74/0833; H04W 88/06

(52) U.S. Cl. CPC H04W 36/0055; H04W 74/0833; H04W 88/06

(57) ABSTRACT

Methods and apparatuses for declaring radio link failure in multi-panel TX scenario are disclosed. A user equipment (UE) comprising multiple panels connected to a network device, wherein, at least one counter and at least one maximum value are configured to the multiple panels, the UE comprises a processor; and a transceiver coupled to the processor, wherein the processor is configured to, at access stratum (AS), determine a problem for a panel or for the UE upon the at least one counter reaching the at least one maximum value; and transmit, via the transceiver, an indication of the problem to upper layers of the UE or to the network device.

### FIELD

The subject matter disclosed herein generally relates to wireless communications, and more particularly relates to methods and apparatuses for declaring radio link failure in multi-panel TX scenario.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), time alignment or timing advance or timing adjustment (TA), Transmit-Receive Point (TRP), Physical Uplink Control Channel (PUCCH), Physical Uplink Shared Channel (PUSCH), Random Access Channel (RACH), Radio Link Control (RLC), service data unit (SDU), radio link failure (RLF), reference signal (RS), control resource set (CORESET), Reference Signal Receiving Power (RSRP), Medium Access Control (MAC).

A cell (e.g. serving cell) may be associated with multiple (e.g. two) TRPs. A UE may transmit UL signals (e.g. PUSCH transmission and/or PUCCH transmission) to multiple TRPs. In NR Release 17, the multiple TRPs are limited to two TRPs. To extend the cell coverage, multiple TRPs are likely to be put in different locations within the cell.

When the UE transmits UL signals to multiple (e.g. two) TRPs of a cell, the UE generally has multiple (e.g. two) panels, each of which is used to transmit UL signal to a different TRP. This can be referred to as multi-panel multi-TRP scenario.

In multi-panel (e.g. two panels: panel #1 and panel #2) multi-TRP (e.g. two TRPs: TRP #1 and TRP #2) scenario, there are multiple (e.g. two) links between UE and two TRPs, e.g. link #1 between panel #1 and TRP #1, and link #2 between panel #2 and TRP #2.

Since there are multiple links (e.g. two links) between the UE and the TRPs, it is possible that at least one link (e.g. link #1) is not problematic and at least one other link (e.g. link #2) is problematic. For example, if a link is not synchronized, the link is problematic.

In legacy, there is only one link for UL transmission. Upon the one link being determined as problematic, the link between the UE and the gNB fails, i.e. radio link failure (RLF) is determined (or RLF is detected).

The link being determined as problematic can be caused by at least the following reasons:
(1) random access problem: suppose TA is not valid for a link, UE performs a RACH procedure to obtain the TA. During the RACH procedure, a preamble is transmitted on the link. If the transmission of the preamble is not successful, the preamble will be retransmitted (i.e. transmitted again). If the transmission times of the preamble reach to a predetermined value, random access problem is determined for the link, and the link is determined as problematic.
(2) max retransmission has been reached: if an RLC SDU is not successfully transmitted, the RLC SDU is retransmitted (i.e. transmitted again). If the transmission times of the RLC SDU reach to a configured number of max retransmission, it is determined that max retransmission has been reached, and the link is determined as problematic.

If there are multiple links, what triggers the determination of the radio link failure (RLF)? If at least one link is determined as problematic, while at least one other link is determined as not-problematic, should the radio link failure (RLF) being triggered?

This invention targets declaring radio link failure in multi-panel TX scenario.

### BRIEF SUMMARY

Methods and apparatuses for declaring radio link failure in multi-panel TX scenario are disclosed.

In one embodiment, a UE comprising multiple panels connected to a network device, wherein, at least one counter and at least one maximum value are configured to the multiple panels, the UE comprises a processor; and a transceiver coupled to the processor, wherein the processor is configured to, at access stratum (AS), determine a problem for a panel or for the UE upon the at least one counter reaching the at least one maximum value; and transmit, via the transceiver, an indication of the problem to upper layers of the UE or to the network device.

In some embodiment, the problem for a panel is random access problem for the panel or RLC retransmissions problem for the panel. In some embodiment, the processor is configured to transmit the indication of the problem to the network device if at least one link between the UE and the network device is available.

In a first implementation, one counter and one maximum value are configured to each of the multiple panels, and the processor is configured to, upon the one counter for one panel reaching the one maximum value for the one panel, determine a problem for the one panel, and transmit the indication of the problem for the panel.

In a second implementation, one counter and one maximum value are configured to each of the multiple panels, and the processor is configured to, upon the one counter for one panel reaching the one maximum value for the one panel, determine a problem for the one panel, and upon determining the problem for all panels, or the problem for at least one panel, or the problem for a configured number of the panels, transmit the indication of the problem for the UE.

In a third implementation, one counter is configured to each of the multiple panels, and one maximum value is configured to all the multiple panels, and the processor is configured to, upon the one counter for one panel reaching the one maximum value for all the multiple panels, determine a problem for the one panel, and transmit the indication of the problem for the panel.

In a fourth implementation, one counter is configured to each of the multiple panels, and one maximum value is configured to all the multiple panels, and the processor is configured to, upon the one counter for one panel reaching the one maximum value for the one panel, determine a problem for the one panel, and upon determining the problem for all panels, or the problem for at least one panel, or the problem for a configured number of the panels, transmit the indication of the problem for the UE.

In a fifth implementation, one counter and one maximum value are configured to all the multiple panels, and the processor is configured to, upon the one counter reaching the one maximum value, determine a problem for the UE, and transmit the indication of the problem for the UE.

In a sixth implementation, one counter and one maximum value are configured to all the multiple panels, and the processor is configured to, upon the one counter reaching the one maximum value due to one panel, determine a problem for the one panel, and transmit the indication of the problem for the one panel.

In some embodiment, the processor is further configured to receive, via the transceiver, at the upper layers, the indication of the problem for the UE; and determine radio link failure for the UE.

In some embodiment, the processor is further configured to receive, via the transceiver, at the upper layers, the indication of the problem for the panels; and determine radio link failure for the UE upon receiving the indication of the problem for all panels, or upon receiving the indication of the problem for at least one panel, or upon receiving the indication of the problem for a configured number of the panels.

In another embodiment, a method performed by a UE comprising multiple panels connected to a network device, wherein, at least one counter and at least one maximum value are configured to the multiple panels, the method comprising: determining a problem for a panel or for the UE at access stratum (AS) upon the at least one counter reaching the at least one maximum value; and transmitting an indication of the problem to upper layers of the UE or to the network device.

In yet another embodiment, a network device comprises multiple links to a UE, each link is associated with one panel of the UE, the network device comprises a processor; and a transceiver coupled to the processor, wherein, the processor is configured to receive, via the transceiver, an indication of problem for a panel or for the UE; and perform a procedure to restore each of the problematic panel(s).

In some embodiment, the processor is configured to receive the indication of problem for the UE on one link, and the problematic panel(s) include all panels of the UE except for the panel associated with the one link.

In further embodiment, a method performed by a network device comprising multiple links to a UE, each link is associated with one panel of the UE, the method comprises receiving an indication of problem for a panel or for the UE; and performing a procedure to restore each of the problematic panel(s).

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 is a schematic flow chart diagram illustrating an embodiment of a method;

FIG. 2 is a schematic flow chart diagram illustrating a further embodiment of a method; and

FIG. 3 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE, 3GPP NR-U, NR Radio Access operating with shared spectrum channel access and so on. It is contemplated that along with the developments of network architectures and new service scenarios, all embodiments in the present application are also applicable to similar technical problems. Moreover, the terminologies recited in the present application may change, which should not affect the principle of the present application. Embodiments of the present disclosure can also be applied to unlicensed spectrum scenario.

To make description clearer, a few concepts are clarified.

TA mentioned in this application refers to time alignment or timing advance or timing adjustment, while TA value in this application (e.g. TA #1 or TA #2) refers to the amount of TA. Generally, TA and TA value can be interchangeable.

“Multi-TRP” means that a serving cell can be associated with multiple (e.g. two) TRPs.

“Multi-panel” means that a UE can have multiple (e.g. two) panels. In the condition that a UE with two panels (e.g. panel #1 and panel #2) transmits UL signal (PUCCH and/or PUSCH transmissions) to a serving cell associated with two TRPs (e.g. TRP #1 and TRP #2), the UE may use one panel (e.g. panel #1) to transmit UL signal to one TRP (e.g. TRP #1) associated with the serving cell and use the other panel (e.g. panel #2) to transmit UL signal to another TRP (e.g. TRP #2) associated with the serving cell.

A link can be indicated as being from a panel to a TRP. Since a particular panel (e.g. panel #1) is used to transmit UL signal to a particular TRP (e.g. TRP #1), a link may be indicated by (or associated with) a panel or a TRP. Similarly, a panel or a TRP can be indicated by (or associated with) a link.

Multiple beams are sent from a panel. In addition, multiple beams used for reception belong to a TRP. Accordingly, a beam or a beam set (or beam group) consisting of multiple beams may alternatively indicate (or be associated with) a panel, and accordingly indicate (or be associated with) a TRP or a link.

A panel corresponds to a set of reference signals (RSs) (maybe referred to as RS set). So, an RS set may alternatively indicate (or be associated with) a panel, and accordingly indicate (or be associated with) a TRP or a link.

A TRP corresponds to a pool of CORESETs with the same CORESETPoolIndex. So, a CORESET pool may alternatively indicate (or be associated with) a TRP, and accordingly indicate (or be associated with) a link or a panel.

Each of the above-identified items to indicate a link or a panel or TRP (e.g. panel, TRP, link, beam, beam set, RS set, CORESET pool) may have an index (or ID), e.g. panel ID, TRP ID, link ID, beam ID, beam set ID, RS set ID, CORESETPoolIndex, which means that the ID of each of the above-identified items may alternatively indicate (or be associated with) a link or a panel or TRP.

According to this disclosure, in multi-TRP operation, multiple links (e.g. two links) are present between a UE and the gNB. For example, link #1 is between panel #1 of the UE and TRP #1 of the gNB; and link #2 is between panel #2 of the UE and TRP #2 of the gNB. The gNB may manage multiple cells. For simplification, it is assumed that all TRPs (e.g. TRP #1 and TRP #2) are associated with the same cell, e.g. the serving cell, or associated with a cell group.

This disclosure is related to determining radio link failure (RLF) in a situation that a UE with multiple panels has multiple links to multiple TRPs of a base station (e.g. gNB) e.g. to multiple TRPs associated with a serving cell of the gNB, where each panel is associated with one of the multiple links.

Radio link failure (RLF) may result from random access problem at MAC layer or RLC retransmissions problem at RLC layer or a combination of different problems (e.g. a combination of random access problem and RLC retransmissions problem). Random access problem means that transmission times of the preamble reach to a predetermined value. RLC retransmissions problem means that the max retransmission of a RLC SDU or the RLC SDU segment has been reached. Traditionally, random access problem or “max retransmission has been reached” (proposed as “RLC retransmissions problem” in this disclosure) is determined for the UE.

In a RACH procedure performed at MAC layer, a preamble is transmitted from UE to a serving cell of the gNB. If the preamble or the UL transmission of the RACH procedure is not transmitted successfully, the preamble will be retransmitted (i.e. transmitted again). Each time the preamble is transmitted, a counter (e.g. PREAMBLE_TRANSMISSION_COUNTER) will be added by 1. A maximum value of the counter (e.g. preambleTransMax) is preconfigured. If the counter (e.g. PREAMBLE_TRANSMISSION_COUNTER) reaches (or becomes equal to) preambleTransMax+1, a random access problem is determined for the UE.

When data is transmitted from UE to a serving cell of the gNB, RLC retransmission at RLC layer may occur if an RLC SDU is not successfully transmitted. Each time an RLC SDU is transmitted, a counter (e.g. RETX_COUNT) is added by 1. A maximum value of the counter (e.g. maxRetxThreshold) is preconfigured, if the counter (e.g. RETX_COUNT) reaches (or becomes equal to) maxRetxThreshold (i.e. maximum retransmission has been reached), a RLC retransmissions problem (i.e. RLC max retransmission) is determined for the UE.

It can be seen the problem (e.g. random access problem or RLC retransmissions problem) for the UE is determined upon the counter for the problem reaching a predetermined value (e.g. the maximum value of the counter (preambleTransMax) plus 1 for the random access problem, or the maximum value of the counter (maxRetxThreshold) for the RLC retransmissions problem).

However, in a scenario that a UE has multiple panels (e.g. two or more panels), the problem (e.g. random access problem or RLC retransmissions problem) may not be the problem for the UE, but may be the problem for the link associated with each panel. In particular, each of the multiple panels is associated with one link. So, multiple panels are associated with the same number of multiple links. In a RACH procedure, a preamble may be transmitted on one of multiple links from UE to a serving cell of the gNB, i.e. from one of the multiple panels of the UE to a TRP (associated with the one panel) associated with the serving cell of the gNB. In addition, data may be also transmitted on one of multiple links, i.e. from one of the multiple panels of the UE to a TRP (associated with the on panel) associated with the serving cell of the gNB. So, the problem (e.g. random access problem or RLC retransmissions problem) may be determined for each link or for each panel associated with the link.

As mentioned above, the random access problem at MAC layer or the RLC retransmissions problem (i.e. RLC max retransmission is reached) at RLC layer can be determined by the same logic. That is, upon the counter for the problem reaching a predetermined value (e.g. the configured maximum value of the counter (preambleTransMax) plus 1 for random access problem or the configured maximum value (maxRetxThreshold) for RLC retransmissions problem), the problem (e.g. random access problem or RLC retransmissions problem) is determined. Incidentally, both preambleTransMax plus 1 and maxRetxThreshold can be regarded as a maximum value. In addition, MAC layer and RLC layer can be collectively referred to as access stratum.

This disclosure proposes the configuration of the counter for the problem, the configuration of the maximum value of the counter, the indication of the problem (e.g. random access problem or RLC retransmissions problem) in the scenario that a UE has multiple panels. The counter (e.g. the counter for the problem), the maximum value of the counter, and the indication of the problem can be configured per panel (i.e. per link) or per MAC entity or per UE. In the condition of non dual connection, per UE is equivalent to per MAC entity. In the condition of dual connection, the counter (e.g. the counter for the problem), the maximum value of the counter, and the indication of the problem can be configured per panel (i.e. per link) per MAC entity. In the following description, per UE is used for both per UE and per MAC entity for ease of discussion.

In the scenario that the UE has multiple panels, this disclosure proposes six different models of configurations of the counter, the maximum value of the counter, and indication of the problem, as provided in below Table 1:

TABLE 1

| | | maximum value of the | indication of the |
|---|---|---|---|
| Model ID | counter | counter | problem |
| 1) | per panel | per panel | per panel |
| 2) | per panel | per panel | per UE |
| 3) | per panel | per UE | per panel |
| 4) | per panel | per UE | per UE |
| 5) | per UE | per UE | per UE |
| 6) | per UE | per UE | per panel |

A first embodiment is described by taking the random access problem as the example of the problem.

For model 1), the counter is configured per panel; the maximum value of the counter is configured per panel; and the indication of the problem is configured per panel. It means that, for each of the multiple panels of the UE, if the counter for the panel reaches the maximum value of the counter for the panel plus 1, the problem (i.e. random access problem) for the panel is determined and indicated.

For example, suppose that the UE has two panels: panel #1 and panel #2. Counter #1 and Max #1 (the maximum value of Counter #1) are configured for panel #1, and Counter #2 and Max #2 (the maximum value of Counter #2) are configured for panel #2.

Each time the preamble is transmitted (or retransmitted) on link #1 associated with panel #1, Counter #1 is added by 1. Upon Counter #1 reaching Max #1+1, the problem (i.e. random access problem) for panel #1 is determined and indicated.

Each time the preamble is transmitted (or retransmitted) on link #2 associated with panel #2, Counter #2 is added by 1. Upon Counter #2 reaching Max #2+1, the problem (i.e. random access problem) for panel #2 is determined and indicated.

The problem (i.e. random access problem) for the panel (e.g. for panel #1, or for panel #2) can be indicated from MAC layer of UE to upper layers (e.g. RRC layer) of the UE. Alternatively, if at least one link (e.g. link #2 associated with panel #2) is still available (or valid) for transmitting the problem indication, the problem (i.e. random access problem) indication for another panel (e.g. panel #1) can be transmitted from UE to the gNB via the at least one available link. After receiving the problem indication for a panel (i.e. problematic panel), the gNB may perform procedure (e.g. a RRC reconfiguration procedure, RRC connection re-establishment procedure or partial RRC connection re-establishment procedure) for the problematic panel, e.g. to restore the problematic panel. RRC reconfiguration procedure is a prior art procedure for reconfiguring RRC connection for a panel. RRC connection re-establishment procedure is a prior art procedure for re-establishing RRC connection for a panel. For a partial RRC connection re-establishment procedure, integrity protection shall be applied to all subsequent messages sent by the UE on the reported problematic panel; ciphering shall be applied to all subsequent messages sent by the UE on the reported problematic panel; and RRCReestablishmentComplete message shall be sent on the reported problematic panel. As a whole, for a partial RRC connection re-establishment procedure, other behaviors are also allowed only if it doesn't include all of the behaviors of RRC connection re-establishment procedure.

If the problem (i.e. random access problem) is determined for a panel, the panel is considered by the UE as abnormal (or suspended), or in an abnormal state (or in a suspended state). In addition or alternatively, if the problem (i.e. random access problem) is determined for a panel, the UE suspends the transmission on the link associated with the panel.

For model 2), the counter is configured per panel; the maximum value of the counter is configured per panel; and the indication of the problem is configured per UE. It means that, for each of the multiple panels of the UE, if the counter for the panel reaches the maximum value of the counter for the panel plus 1, the random access problem for the panel is determined. Upon the random access problem being determined for all the multiple panels or for at least one of the multiple panels or for at least a configured number of panels, the random access problem for the UE is indicated.

For example, suppose that the UE has three panels: panel #1, panel #2 and panel #3. Counter #1 and Max #1 (the maximum value of Counter #1) are configured for panel #1, Counter #2 and Max #2 (the maximum value of Counter #2) are configured for panel #2, and Counter #3 and Max #3 (the maximum value of Counter #3) are configured for panel #3.

Each time the preamble is transmitted on link #1 associated with panel #1, Counter #1 is added by 1. Upon Counter #1 reaching Max #1+1, the random access problem for panel #1 is determined.

Each time the preamble is transmitted on link #2 associated with panel #2, Counter #2 is added by 1. Upon Counter #2 reaching Max #2+1, the random access problem for panel #2 is determined.

Each time the preamble is transmitted on link #3 associated with panel #3, Counter #3 is added by 1. Upon Counter #3 reaching Max #3+1, the random access problem for panel #3 is determined.

Upon the random access problem being determined for all panels (e.g. all of panel #1, panel #2 and panel #3), the random access problem for the UE is indicated.

Alternatively, upon the random access problem being determined for at least one of panel #1, panel #2 and panel #3, the random access problem for the UE is indicated.

Further alternatively, upon the random access problem being determined for at least two (e.g. the configured number of panels is 2) of panel #1, panel #2 and panel #3, the random access problem for the UE is indicated.

The problem for the UE can be indicated from MAC layer of UE to upper layers (e.g. RRC layer) of the UE. Alternatively, if at least one link is still available for transmitting the problem indication, the problem indication for the UE can be transmitted from the UE to the gNB via the at least one available link. After receiving the problem for the UE, the gNB may respond with a procedure (e.g. RRC reconfiguration procedure or RRC connection re-establishment procedure or partial RRC connection re-establishment procedure) to restore each of the problematic panel(s). For example, the gNB may consider that the panel associated with the link on which the problem indication is received is available (i.e. is not problematic) while the other panel(s) of the UE are problematic.

Each panel for which the problem is determined is considered by the UE as abnormal (or suspended), or in an abnormal state (or in a suspended state). In addition or alternatively, if the problem is determined for a panel, the UE suspends the transmission on the link associated with the panel.

For model 3), the counter is configured per panel; the maximum value of the counter is configured per UE; and the indication of the problem is configured per panel. It means that, for each of the multiple panels of the UE, if the counter for the panel reaches the maximum value of the counter plus 1, the random access problem for the panel is determined and indicated.

For example, suppose that the UE has two panels: panel #1 and panel #2. Counter #1 is configured for panel #1, and Counter #2 is configured for panel #2. A common maximum value of the counter (e.g. Max) is configured for all panels (e.g. panel #1 and panel #2).

Each time the preamble is transmitted on link #1 associated with panel #1, Counter #1 is added by 1. Upon Counter #1 reaching Max+1, the random access problem for panel #1 is determined and indicated.

Each time the preamble is transmitted on link #2 associated with panel #2, Counter #2 is added by 1. Upon Counter #2 reaching Max+1, the random access problem for panel #2 is determined and indicated.

The random access problem for the panel (e.g. for panel #1, or for panel #2) can be indicated from MAC layer of UE to upper layers (e.g. RRC layer) of the UE. Alternatively, if at least one link (e.g. link #2 associated with panel #2) is still available for transmitting the problem indication, the problem indication for another panel (e.g. panel #1) can be transmitted from the UE to the gNB via the at least one available link. After receiving the problem for a panel, the gNB may perform a procedure (e.g. RRC reconfiguration procedure or connection re-establishment procedure or partial RRC connection re-establishment procedure) to restore the problematic panel.

If the problem (i.e. random access problem) is determined for a panel, the panel is considered by the UE as abnormal (or suspended), or in an abnormal state (or in a suspended state). In addition or alternatively, if the problem (i.e. random access problem) is determined for a panel, the UE suspends the transmission on the link associated with the panel.

For model 4), the counter is configured per panel; the maximum value of the counter is configured per UE; and the indication of the problem is configured per UE. It means that, for each of the multiple panels of the UE, if the counter reaches the maximum value of the counter plus 1, the random access problem for the panel is determined. Upon the random access problem being determined for all the multiple panels or for at least one of the multiple panels or for at least a configured number of panels, the random access problem for the UE is indicated.

For example, suppose that the UE has three panels: panel #1, panel #2, and panel #3. Counter #1 is configured for panel #1, Counter #2 is configured for panel #2, and Counter #3 is configured for panel #3. A common maximum value of the counter (e.g. Max) is configured for all panels, i.e. panel #1, panel #2, and panel #3.

Each time the preamble is transmitted on link #1 associated with panel #1, Counter #1 is added by 1. Upon Counter #1 reaching Max+1, the random access problem for panel #1 is determined.

Each time the preamble is transmitted on link #2 associated with panel #2, Counter #2 is added by 1. Upon Counter #2 reaching Max+1, the random access problem for panel #2 is determined.

Each time the preamble is transmitted on link #3 associated with panel #3, Counter #3 is added by 1. Upon Counter #3 reaching Max+1, the random access problem for panel #3 is determined.

Upon the random access problem being determined for all panels (e.g. all of panel #1, panel #2 and panel #3), the random access problem for the UE is indicated.

Alternatively, upon the random access problem being determined for at least one of panel #1, panel #2 and panel #3, the random access problem for the UE is indicated.

Further alternatively, upon the random access problem being determined for at least two (e.g. the configured number of panels is 2) of panel #1, panel #2 and panel #3, the random access problem for the UE is indicated.

The problem for the UE can be indicated from MAC layer of UE to upper layers (e.g. RRC layer) of the UE. Alternatively, if at least one link is still available for transmitting the problem indication, the problem indication for the UE can be transmitted from UE to the gNB via the at least one available link. After receiving the problem for the UE, the gNB may perform a procedure (e.g. RRC reconfiguration procedure or RRC connection re-establishment procedure or partial RRC connection re-establishment procedure) to restore each of the problematic panel(s). For example, the gNB may consider that the panel associated with the link on which the problem indication is received is available (i.e. is not problematic) while the other panel(s) of the UE are problematic.

Each panel for which the problem is determined is considered by the UE as abnormal (or suspended), or in an abnormal state (or in a suspended state). In addition or alternatively, if the problem is determined for a panel, the UE suspends the transmission on the link associated with the panel.

For model 5), the counter is configured per UE; the maximum value of the counter is configured per UE; and the indication of the problem is configured per UE. It means that, if the counter for the UE reaches the maximum value of the counter plus 1, the random access problem for the UE is determined and indicated.

For example, suppose that the UE has two panels: panel #1 and panel #2. One counter (e.g. Counter) and one maximum value of Counter (e.g. Max) are configured for all panels (e.g. panel #1 and panel #2).

Each time the preamble is transmitted on link #1 associated with panel #1, Counter is added by 1. Each time the preamble is transmitted on link #2 associated with panel #2, Counter is also added by 1. Upon Counter reaching Max+1, the random access problem for the UE is determined and indicated.

The problem for the UE can be indicated from MAC layer of UE to upper layers (e.g. RRC layer) of the UE.

For model 6), the counter is configured per UE; the maximum value of the counter is configured per UE; and the indication of the problem is configured per panel. Model 6) is a special example of model 5). Although the counter is configured per UE that has multiple panels, only one of the multiple panels is used. Accordingly, if the counter for the UE reaches the maximum value of the counter plus 1, the random access problem for the only-used panel is determined and indicated.

For example, suppose that the UE has two panels: panel #1 and panel #2. One counter (e.g. Counter) and one maximum value of Counter (e.g. Max) are configured for all panels (e.g. panel #1 and panel #2).

If only panel #1 is used while panel #2 is not used, each time the preamble is transmitted on link #1 associated with panel #1, Counter is added by 1. As panel #2 is not used, preamble is not transmitted on link #2 associated with panel #2. Upon Counter reaching Max+1, the random access problem for panel #1 is determined and indicated.

The random access problem for the only-used panel (e.g. panel #1) can be indicated from MAC layer of UE to upper layers (e.g. RRC layer) of the UE. Alternatively, if at least one link (e.g. link #2 associated with panel #2) is available for transmitting the problem indication, the problem indication for the only-used panel can be indicated from UE to gNB via the at least one available link. The gNB may response with a procedure (e.g. RRC reconfiguration procedure or RRC connection re-establishment procedure or partial RRC connection re-establishment procedure) to restore the problematic panel (i.e. the only-used panel).

Each panel for which the problem is determined is considered by the UE as abnormal (or suspended), or in an abnormal state (or in a suspended state). In addition or alternatively, if the problem is determined for a panel, the UE suspends the transmission on the link associated with the panel.

For each of the models 1), 3) and 6), the indication of the random access problem for a panel may be a new failure type (e.g. RAforonepanelfailure or problemforonepanel). The new failure type RAforonepanelfailure is only applied to random access problem, while the new failure type problemforonepanel may apply both random access problem and RLC retransmissions problem. If the problem indication per panel is received by RRC layer of the UE, the RRC layer may temporarily stores the problem indication per panel. The RRC layer of the UE may consider radio link failure to be detected upon the problem indications for all of the panels being received, or upon the problem indications for at least a configured number of panels being received, or upon the problem indication for at least one panel being received. It is obvious that if the RRC layer of the UE considers radio link failure to be detected upon the problem indication for one panel being received, it is unnecessary to store the problem indication per panel. For each of the models 2), 4) and 5), the indication of the random access problem for the UE can be regarded as radio link failure. It means that, upon receiving the indication of the random access problem for the UE, the RRC layer of the UE determines a radio link failure (or considers radio link failure to be detected).

A second embodiment is described by taking the RLC retransmissions problem as the example of the problem.

The second embodiment differs from the first embodiment only in that the problem is the RLC retransmissions problem instead of the random access problem.

For the RLC retransmissions problem, the counter may be a variable per RLC SDU. Whether the counter or the maximum value of the counter is per panel is decided by the logical channel associated with the RLC entity. A logical channel is mapped to a configured grant. The configured grant is associated with one of the multiple panels. Alternatively, a logical channel is allocated resources and the resources are associated with one of the multiple panels. The association of the logical channel with specific panel is not limited to the above described two manners, but can be other manners. In the condition that the logical channel is associated with a specific panel, the counter or the maximum value of the counter is per panel.

In particular, the second embodiment differs from the first embodiment only in that:
(1) For each of models 1) to 6), each time the RLC SDU is transmitted (or retransmitted), the counter is added by 1.
(2) For each of models 1) to 6), the RLC retransmissions problem is determined when the counter reaches the maximum value of the counter.
(3) For each of the models 1), 3) and 6), the indication of the RLC retransmissions problem for a panel may be a new failure type (e.g. maxreTXforonepanelreached or problemforonepanel). The new failure type maxreTXforonepanelreached is only applied to RLC retransmissions problem, while the new failure type problemforonepanel may apply both random access problem and RLC retransmissions problem. For each of the models 2), 4) and 5), the indication of the RLC retransmissions problem for the UE can be regarded as radio link failure.
(4) The indication of random access problem according to the first embodiment is transmitted from MAC layer, while the indication of RLC retransmissions problem according to the second embodiment is transmitted from RLC layer.

According to a third embodiment, the problem may be the random access problem and the RLC retransmissions problem, and/or other problem that may cause radio link failure.

In the third embodiment, the problem may be a combination of random access problem for some panel(s) (i.e. some links associated with some panels) and the RLC retransmissions problem for some other panel(s) (i.e. some other links associated with some other panels).

The problem for one panel can be the random access problem for the one panel, or the RLC retransmissions problem for the one panel, or other problem that may cause radio link failure for the one panel.

The problem for random access problem is determined at MAC layer, while the problem for RLC retransmissions problem is determined at RLC layer (different from MAC layer). Accordingly, neither the MAC layer nor the RLC layer can indicate the problem per UE. In other words, the MAC layer or the RLC layer can only indicate the problem per panel (i.e. only models 1), 3) and 6) apply).

If the problem indication per panel is transmitted or indicated to RRC layer of the UE, the RRC layer may temporarily stores the problem indication per panel. The RRC layer of the UE may consider radio link failure to be detected upon the problem indications for all of the panels being received, or upon the problem indications for at least a configured number of panels being received, or upon the problem indication for at least one panel being received.

If at least one link is still available for transmitting the problem indication, the problem indication for a panel can be transmitted to the gNB. After receiving the problem indication for a panel, the gNB may perform a procedure (e.g. RRC reconfiguration procedure or RRC connection re-establishment procedure or partial RRC connection re-establishment procedure) to restore the problematic panel.

For example, if the serving cell of the gNB is associated with two links (and accordingly two panels of the UE), upon the random access problem being determined for one panel and indicated to RRC layer of the UE, and the RLC retransmissions problem being determined for another panel and indicated to RRC layer of the UE, the RRC layer may consider radio link failure to be detected for the UE.

For another example, if the serving cell of the gNB is associated with three links (and accordingly three panels of the UE, e.g. panel #1, panel #2 and panel #3), if the problem is determined for two panels (e.g. panel #2 and panel #3), for example, the random access problem is determined for panel #2 and indicated to RRC layer of the UE, and the RLC retransmissions problem is determined for panel #3 and indicated to the RRC layer of the UE, the RRC layer may consider radio link failure to be detected since problem indications for the configured number of panels (suppose the configured number of panels is two) are received.

FIG. 1 is a schematic flow chart diagram illustrating an embodiment of a method 100 according to the present application. In some embodiments, the method 100 is performed by an apparatus, such as a remote unit (UE). In certain embodiments, the method 100 may be performed by a processor executing program code, for example, a microcontroller, a microprocessor, a CPU, a GPU, an auxiliary processing unit, a FPGA, or the like.

The method 100 may be performed by a UE, the UE comprises multiple panels connected to a network device, wherein, at least one counter and at least one maximum value are configured to the multiple panels, the method 100 comprising: 110 determining a problem for a panel or for the UE at access stratum (AS) upon the at least one counter reaching the at least one maximum value; and 120 transmitting an indication of the problem to upper layers of the UE or to the network device.

In some embodiment, the problem for a panel is random access problem for the panel or RLC retransmissions problem for the panel.

In some embodiment, the indication of the problem is transmitted to the network device if at least one link between the UE and the network device is available.

In a first implementation, one counter and one maximum value are configured to each of the multiple panels: upon the one counter for one panel reaching the one maximum value for the one panel, a problem for the one panel is determined; and the indication of the problem for the panel is transmitted.

In a second implementation, one counter and one maximum value are configured to each of the multiple panels: upon the one counter for one panel reaching the one maximum value for the one panel, a problem for the one panel is determined; and upon determining the problem for all panels, or the problem for at least one panel, or the problem for a configured number of the panels, the indication of the problem for the UE is transmitted.

In a third implementation, one counter is configured to each of the multiple panels, and one maximum value is configured to all the multiple panels: upon the one counter for one panel reaching the one maximum value for all the multiple panels, a problem for the one panel is determined; and the indication of the problem for the panel is transmitted.

In a fourth implementation, one counter is configured to each of the multiple panels, and one maximum value is configured to all the multiple panels: upon the one counter for one panel reaching the one maximum value for the one panel, a problem for the one panel is determined; and upon determining the problem for all panels, or the problem for at least one panel, or the problem for a configured number of the panels, the indication of the problem for the UE is transmitted.

In a fifth implementation, one counter and one maximum value are configured to all the multiple panels: upon the one counter reaching the one maximum value, a problem for the UE is determined; and the indication of the problem for the UE is transmitted.

In a sixth implementation, one counter and one maximum value are configured to all the multiple panels: upon the one counter reaching the one maximum value due to one panel, a problem for the one panel is determined; and the indication of the problem for the one panel is transmitted.

In some embodiment, the method may further comprise receiving, at the upper layers, the indication of the problem for the UE; and determining radio link failure for the UE.

In some embodiment, the method may further comprise receiving, at the upper layers, the indication of the problem for the panels; and determining radio link failure for the UE upon receiving the indication of the problem for all panels, or upon receiving the indication of the problem for at least one panel, or upon receiving the indication of the problem for a configured number of the panels.

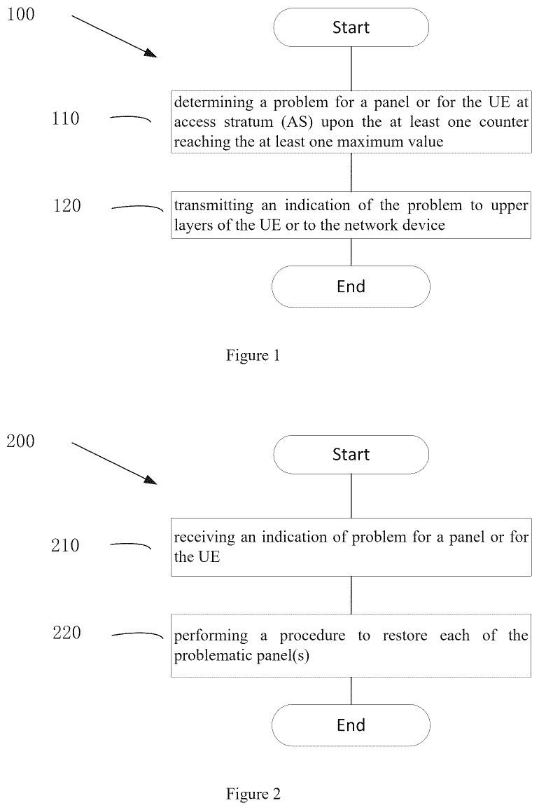

FIG. 2 is a schematic flow chart diagram illustrating a further embodiment of a method 200 according to the present application. In some embodiments, the method 200 is performed by an apparatus, such as a base unit or a network device. In certain embodiments, the method 200 may be performed by a processor executing program code, for example, a microcontroller, a microprocessor, a CPU, a GPU, an auxiliary processing unit, a FPGA, or the like.

The method 200 may be performed by a network device, the network device, comprising multiple links to a UE, each link is associated with one panel of the UE, the method comprising 210 receiving an indication of problem for a panel or for the UE; and 220 performing a procedure to restore each of the problematic panel(s).

In some embodiment, if the indication of problem for the UE is received on one link, the problematic panel(s) include all panels of the UE except for the panel associated with the one link.

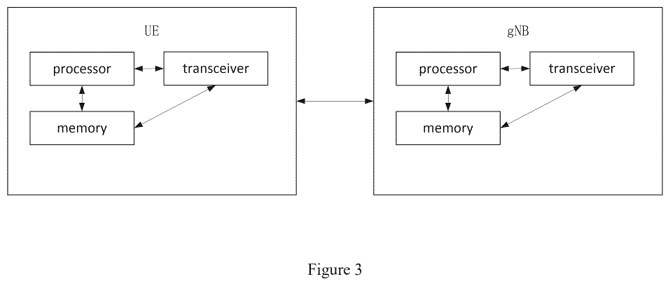

FIG. 3 is a schematic block diagram illustrating apparatuses according to one embodiment.

Referring to FIG. 3, the UE (i.e. remote unit, or terminal device) includes a processor, a memory, and a transceiver. The processor implements a function, a process, and/or a method which are proposed in FIG. 1.

The UE comprising multiple panels connected to a network device, wherein, at least one counter and at least one maximum value are configured to the multiple panels, the UE comprising a processor; and a transceiver coupled to the processor, wherein the processor is configured to, at access stratum (AS), determine a problem for a panel or for the UE upon the at least one counter reaching the at least one maximum value; and transmit, via the transceiver, an indication of the problem to upper layers of the UE or to the network device.

In some embodiment, the problem for a panel is random access problem for the panel or RLC retransmissions problem for the panel.

In some embodiment, the processor is configured to transmit the indication of the problem to the network device if at least one link between the UE and the network device is available.

In a first implementation, one counter and one maximum value are configured to each of the multiple panels, and the processor is configured to, upon the one counter for one panel reaching the one maximum value for the one panel, determine a problem for the one panel, and transmit the indication of the problem for the panel.

In a second implementation, one counter and one maximum value are configured to each of the multiple panels, and the processor is configured to, upon the one counter for one panel reaching the one maximum value for the one panel, determine a problem for the one panel, and upon determining the problem for all panels, or the problem for at least one panel, or the problem for a configured number of the panels, transmit the indication of the problem for the UE.

In a third implementation, one counter is configured to each of the multiple panels, and one maximum value is configured to all the multiple panels, and the processor is configured to, upon the one counter for one panel reaching the one maximum value for all the multiple panels, determine a problem for the one panel, and transmit the indication of the problem for the panel.

In a fourth implementation, one counter is configured to each of the multiple panels, and one maximum value is configured to all the multiple panels, and the processor is configured to, upon the one counter for one panel reaching the one maximum value for the one panel, determine a problem for the one panel, and upon determining the problem for all panels, or the problem for at least one panel, or the problem for a configured number of the panels, transmit the indication of the problem for the UE.

In a fifth implementation, one counter and one maximum value are configured to all the multiple panels, and the processor is configured to, upon the one counter reaching the one maximum value, determine a problem for the UE, and transmit the indication of the problem for the UE.

In a sixth implementation, one counter and one maximum value are configured to all the multiple panels, and the processor is configured to, upon the one counter reaching the one maximum value due to one panel, determine a problem for the one panel, and transmit the indication of the problem for the one panel.

In some embodiment, the processor is further configured to receive, via the transceiver, at the upper layers, the indication of the problem for the UE; and determine radio link failure for the UE.

In some embodiment, the processor is further configured to receive, via the transceiver, at the upper layers, the indication of the problem for the panels; and determine radio link failure for the UE upon receiving the indication of the problem for all panels, or upon receiving the indication of the problem for at least one panel, or upon receiving the indication of the problem for a configured number of the panels.

Referring to FIG. 3, the gNB (i.e. base unit or network device) comprises multiple links to a UE, each link is associated with one panel of the UE, the gNB comprises a processor; and a transceiver coupled to the processor, wherein, the processor is configured to receive, via the transceiver, an indication of problem for a panel or for the UE; and perform a procedure to restore each of the problematic panel(s).

In some embodiment, the processor is configured to receive the indication of problem for the UE on one link, and the problematic panel(s) include all panels of the UE except for the panel associated with the one link.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A user equipment (UE) for wireless communication having
multiple panels connected to a network device, wherein at least one counter and at least one maximum value are configured to the multiple panels, the UE comprising:
at least one memory; and
at least one processor coupled with the at least one memory and configured to cause the UE to:
at access stratum (AS), determine a problem for a panel or for the UE when the at least one counter reaches the at least one maximum value; and
transmit an indication of the determined problem to upper layers of the UE or to the network device.

2. The UE of claim 1, wherein, the problem for the panel is a random access problem for the panel or a radio link control (RLC) retransmissions problem for the panel.

3. The UE of claim 1, wherein, the at least one processor is configured to cause the UE to transmit the indication of the problem to the network device if at least one link between the UE and the network device is available.

4. The UE of claim 1, wherein, one counter and one maximum value are configured to each of the multiple panels, and
wherein the at least one processor is further configured to cause the UE to, when the one counter for one panel reaches the one maximum value for the one panel, determine a problem for the one panel, and
transmit the indication of the determined problem for the one panel.

5. The UE of claim 1, wherein, one counter and one maximum value are configured to each of the multiple panels, and
wherein the at least one processor is further configured to cause the UE to:
when the one counter for one panel reaches the one maximum value for the one panel, determine a problem for the one pane, and
upon determining the problem for all panels, determining the problem for at least one panel, or determining the problem for a configured number of the multiple panels, transmit the indication of the problem for the UE.

6. The UE of claim 1, wherein, one counter is configured to each of the multiple panels, and one maximum value is configured to all the multiple panels, and
the processor is configured to, upon the one counter for one panel reaching the one maximum value for all the multiple panels, determine a problem for the one panel, and
transmit the indication of the problem for the panel.

7. The UE of claim 1, wherein, one counter is configured to each of the multiple panels, and one maximum value is configured to all panels the multiple panels, and
wherein the at least one processor is configured to cause the UE to:
when the one counter for one panel reaches the one maximum value for the one panel, determine a problem for the one panel, and
upon determining the problem for all panels, determining the problem for at least one panel, or determining the problem for a configured number of the panels, transmit the indication of the problem for the UE.

8. The UE of claim 1, wherein, one counter and one maximum value are configured to all the multiple panels, and
wherein the at least one processor is configured to cause the UE to:
when the one counter reaches the one maximum value, determine a problem for the UE, and
transmit the indication of the problem for the UE.

9. The UE of claim 1, wherein, one counter and one maximum value are configured to all the multiple panels, and
wherein the at least one processor is configured to cause the UE to:
when the one counter reaches the one maximum value for one panel, determine a problem for the one panel, and
transmit the indication of the problem for the one panel.

10. The UE of claim 1, wherein, the at least one processor is further configured to cause the UE to:
receive, at the upper layers, the indication of the problem for the UE; and
determine a radio link failure for the UE.

11. The UE of claim 1, wherein, the at least one processor is further configured to cause the UE to:
receive, at the upper layers, the indication of the problem for the panels; and
determine a radio link failure for the UE upon receiving the indication of the problem for all panels, upon receiving the indication of the problem for at least one panel, or upon receiving the indication of the problem for a configured number of the panels.

12. A method performed by a user equipment (UE), wherein the UE comprises multiple panels connected to a network device, and wherein at least one counter and at least one maximum value are configured to the multiple panels, the method comprising:
determining, at access stratum (AS), a problem for a panel or for the UE upon the at least one counter reaching the at least one maximum value; and
transmitting an indication of the problem to upper layers of the UE or to the network device.

13. A network device for wireless communication having multiple links to a user equipment (UE), wherein each link is associated with one panel of the UE, the network device comprising:
at least one memory; and
at least one processor coupled with the at least one memory and configured to cause the network device to:
receive, an indication of a problem for a panel or for the UE; and
perform a procedure to restore one or more panels associated with the indication of the problem for the panel or for the UE.

14. The network device of claim 13, wherein, the at least one processor is configured to cause the network device to: receive the indication of the problem for the UE on one link, wherein
the one or more panels associated with the indication of the problem include all panels of the UE except for a panel associated with the one link.

15. A processor for wireless communication, comprising:
at least one controller coupled with at least one memory and configured to cause the processor to:
at access stratum (AS), determine a problem for a panel of the processor or for the processor when at least one counter configured for multiple panels of the processor reaches at least one maximum value configured for the multiple panels; and
transmit an indication of the determined problem to upper layers of the UE or to the network device.

16. The processor of claim 15, wherein the problem for the panel is a random access problem for the panel or a radio link control (RLC) retransmissions problem for the panel.

17. The processor of claim 15, wherein the at least one controller is configured to cause the processor to transmit the indication of the problem to the network device if at least one link between the UE and the network device is available.

18. The processor of claim 15, wherein one counter and one maximum value are configured to each of the multiple panels, and
wherein the at least one controller is further configured to cause the processor to, when the one counter for one panel reaches the one maximum value for the one panel, determine a problem for the one panel, and
transmit the indication of the determined problem for the one panel.

19. The processor of claim 15, wherein the at least one controller is further configured to cause the processor to:
receive, at the upper layers, the indication of the problem for the processor; and
determine a radio link failure for the processor.

20. The processor of claim 15, wherein the at least one controller is further configured to cause the processor to:
receive, at the upper layers, the indication of the problem for the panels; and
determine a radio link failure for the processor upon receiving the indication of the problem for all panels, upon receiving the indication of the problem for at least one panel, or upon receiving the indication of the problem for a configured number of the panels.
